(19) United States
(12) Patent Application Publication
(10) Pub. No.: US 2011/0223352 A1
(43) Pub. Date: Sep. 15, 2011

(54) Method of making a keycap structure

(76) Inventor: Chih-Chao Chen, Taoyuan (TW)

(21) Appl. No.: 12/834,906

(22) Filed: Jul. 13, 2010

(30) Foreign Application Priority Data
Mar. 15, 2010 (TW) 099107412

(51) Int. Cl. B05D 3/06; B05D 3/02

(52) U.S. Cl. 427/554

(57) ABSTRACT

A method of making a keycap structure including steps of colored plastic body formation, final coating spraying, baking, laser engraving, transparent layer covering, and finishing. Through the aforesaid steps, at least a colored plastic body is pre-formed. The colored plastic body has a to-be-processed surface. The to-be-processed surface is spray-coated with a final coating. The colored plastic body and the final coating are baked to allow the final coating to harden on the to-be-processed surface. The final coating is processed by a laser beam to format least a hollowed portion. The hollowed portion of the final coating and the correspondingly exposed to-be-processed surface together constitute at least a pattern portion. The pattern portion and the final coating are covered with a transparent layer to protect the pattern portion and the final coating, and a keycap structure is finished from the colored plastic body.

### BACKGROUND OF THE INVENTION

1. Field of the Invention

The present invention relates to a making method, and particularly a method of making a keycap structure, in which, complicated patterns as well as ones on a non-planar surface can be precisely formed.

2. Description of the Prior Art

A keycap can be conventionally made in two manners. One, as shown in FIG. 11, is directly to forma colored keycap 81 and directly to print at least a pattern 811 on the colored keycap 81. The other, as shown in FIG. 12 (including a perspective view and a cross-sectional view), is to form a colorless keycap 81A, to spray a color layer 81B on the colorless keycap 81A, and to print at least a pattern 811 on the color layer 81B.

The conventional manners are easily accompanied with problems that complicated patterns can not be well made or defects tend to occur on non-planar surface. As shown in FIG. 11, if the pattern 811 being much-complicated or having very dense lines is directly printed on the colored keycap 81, two lines easily meet each other to form a defect 812, resulting in an unclear or indiscernible pattern. As shown in FIG. 12, if the keycap has a non-planar surface, such as a concave surface, the printed pattern 811 tends to deform to become a defect.

Therefore, there is a need for a novel technique to solve the aforesaid problems.

### SUMMARY OF THE INVENTION

One objective of the present invention is to provide a method of making a keycap structure, by which complicated patterns can be precisely made, even on a non-planar surface. Particularly, the present invention can solve the problems that complicated patterns can not be well made, defects tend to occur on non-planar surface, and the like.

The means to solve the above-mentioned problems is to provide a method of making a keycap structure, which includes steps of colored plastic body formation, final coating spraying, baking, laser engraving, transparent layer covering, and finishing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart illustrating the first embodiment according to the present invention;

FIGS. 2A, 2B, 2C, and 2D are schematic cross-sectional views respectively illustrating steps of the process in the first embodiment of the present invention;

FIG. 3 is a schematic diagram illustrating a finished product of the first embodiment according to the present invention;

FIG. 4 is a flow chart illustrating the second embodiment according to the present invention;

FIG. 5 is a schematic cross-sectional view illustrating the second embodiment according to the present invention;

FIG. 6 is a flow chart illustrating the third embodiment according to the present invention;

FIG. 7 is a schematic cross-sectional view illustrating the third embodiment according to the present invention;

FIG. 8 is a schematic diagram illustrating a finished product of the third embodiment according to the present invention;

FIG. 9 is a schematic diagram illustrating other embodiment of the to-be-processed surface of the present invention;

FIG. 10 is a schematic exploded diagram illustrating an application of the present invention to a key;

FIG. 11 is a schematic diagram illustrating the first conventional structure; and

FIG. 12 is a schematic diagram illustrating the second conventional structure.

### DETAILED DESCRIPTION

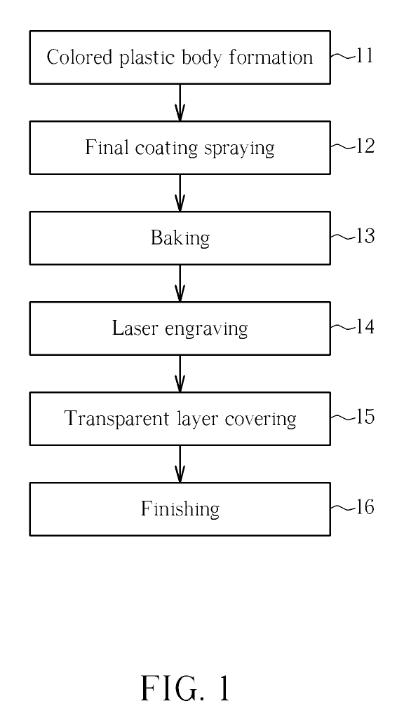

Referring FIG. 1, a first embodiment of the method of making a keycap structure according to the present invention comprises steps as follows.

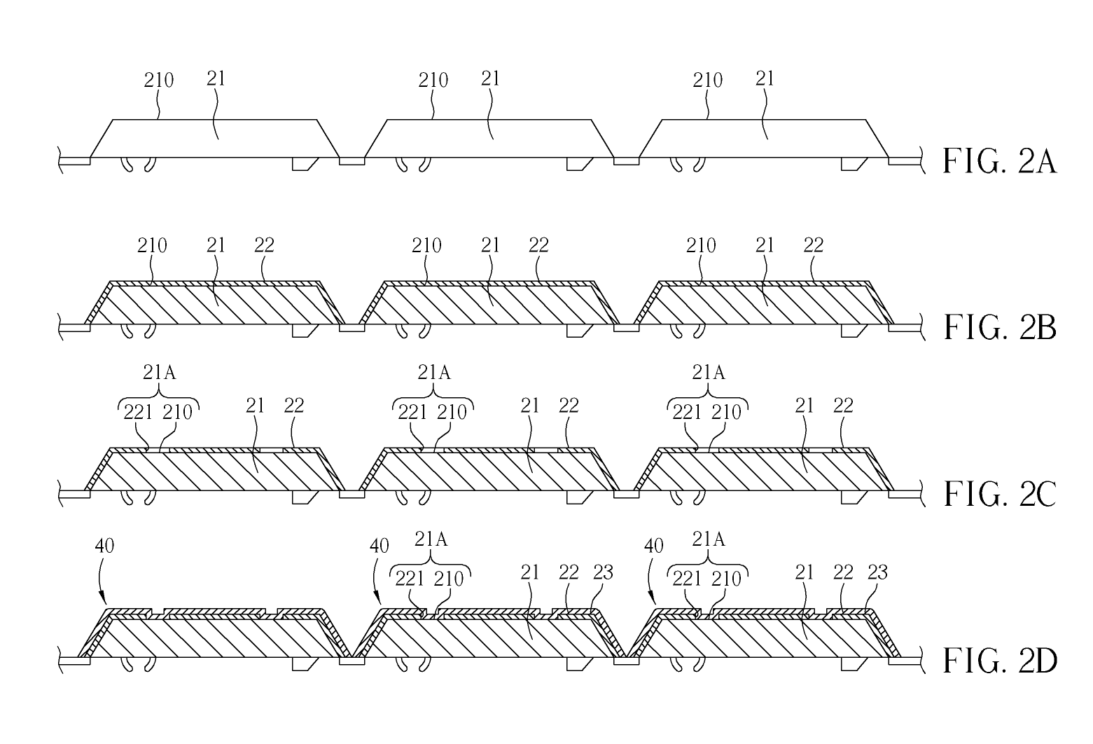

Step 11 of colored plastic body formation: referring to FIG. 2A, at least a colored plastic body 21 is pre-formed. The colored plastic body 21 has a to-be-processed surface 210.

Step 12 of final coating spraying: referring to FIG. 2B, the to-be-processed surface 210 is spray-coated with a final coating 22.

Step 13 of baking: the colored plastic body 21 and the final coating 22 are baked to allow the final coating 22 to harden on the to-be-processed surface 210.

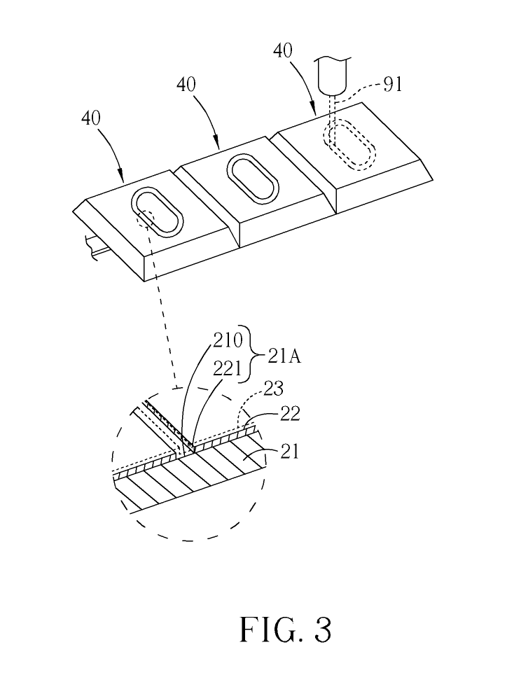

Step 14 of laser engraving: referring to FIG. 3, a laser beam 91 is utilized to process the final coating 22 to form at least a hollowed portion 221. The hollowed portion 221 and the correspondingly exposed to-be-processed surface 210 together constitute at least a pattern portion 21A (referring to FIG. 2C).

Step 15 of transparent layer covering: referring to FIG. 2D, the pattern portion 21A and the final coating 22 are covered with a transparent layer 23 for protecting the pattern portion 21A and the final coating 22.

Step 16 of finishing: a finishing process is performed on the at least a colored plastic body 21 to obtain a keycap structure 40.

In an embodiment, in Step 11, the colored plastic body 21 may be pre-formed through injection-molding a colored plastic material (or a colorless plastic material added with a pigment).

In Step 14, the pattern portion 21A may present a character, letter, decorative design, figure, symbol, or number, for indication. Obvious varied techniques to engrave the final coating 22 are replaceable and are accordingly within the scope of the present invention.

A plurality of keycap structures 40 may be made on a production line and then cut or punched to become singular; therefore, it benefits automatic production. FIG. 3 shows three keycap structures for illustration. However, obvious amount variation is within the scope of the present invention.

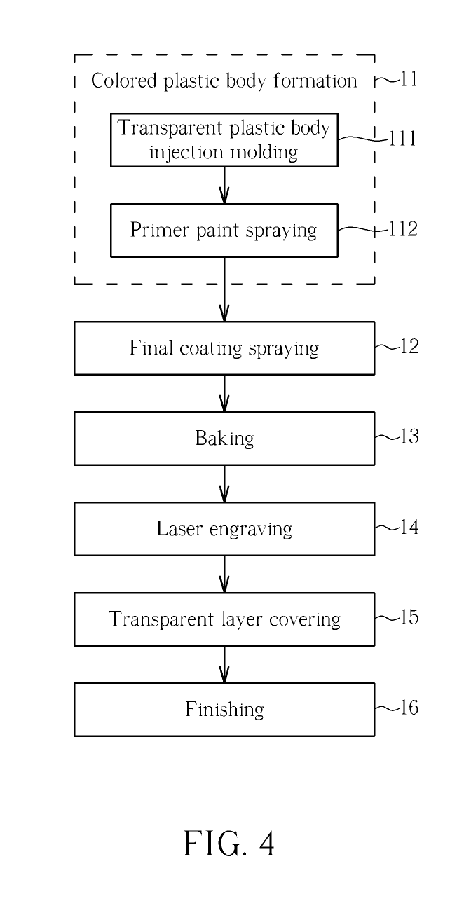

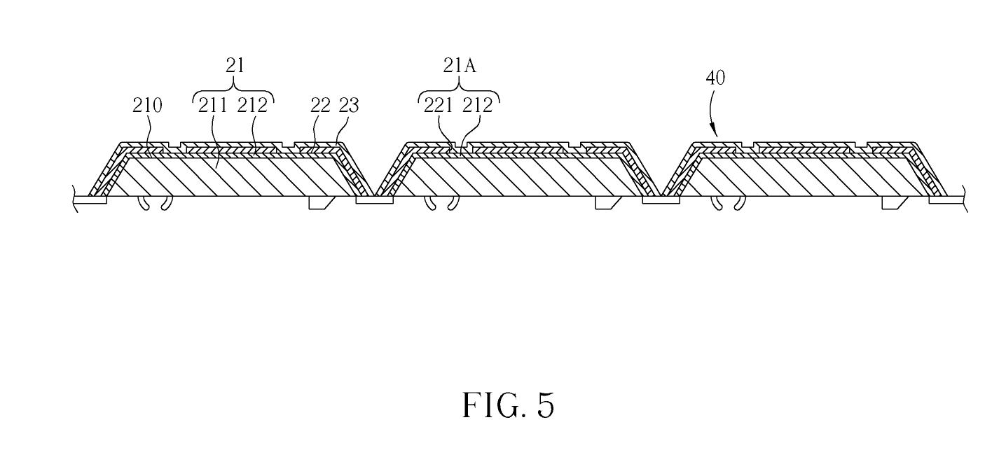

FIGS. 4 and 5 illustrate the second embodiment of the present invention, which is substantially the same as the first embodiment. The only difference is that Step 11 further includes:

Step 111 of transparent plastic body injection molding: injection-molding a transparent plastic material to pre-form a transparent plastic body 211, and

Step 112 of primer paint spraying: spray-coating the transparent plastic body 211 with a primer paint 212, wherein a surface of the primer paint 212 is the to-be-processed surface 210. As such, the transparent plastic body 211 and the primer paint 212 constitute the colored plastic body 21. The hollowed portion 221 and the correspondingly exposed primer paint 212 constitute the at least a pattern portion 21A.

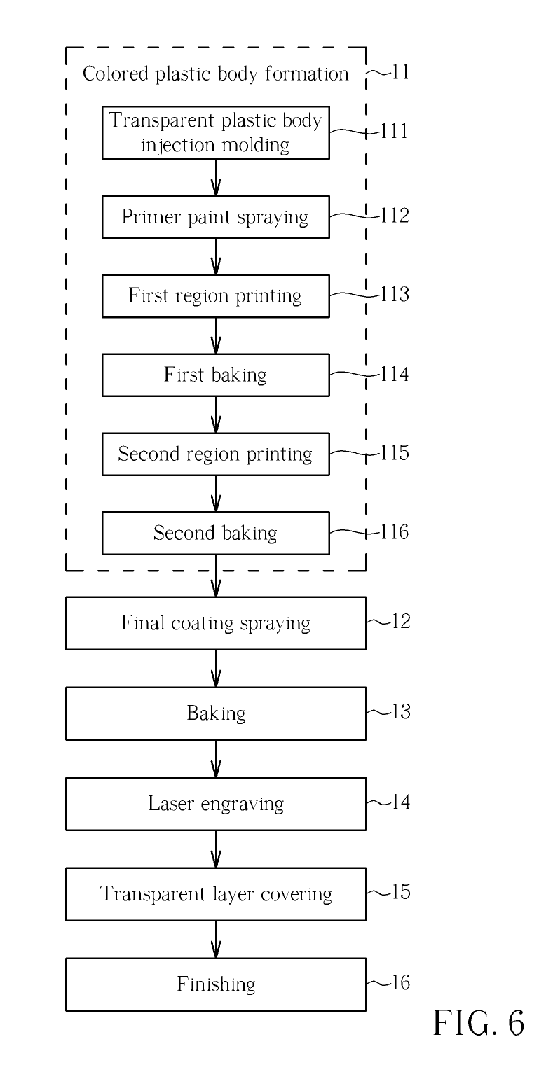

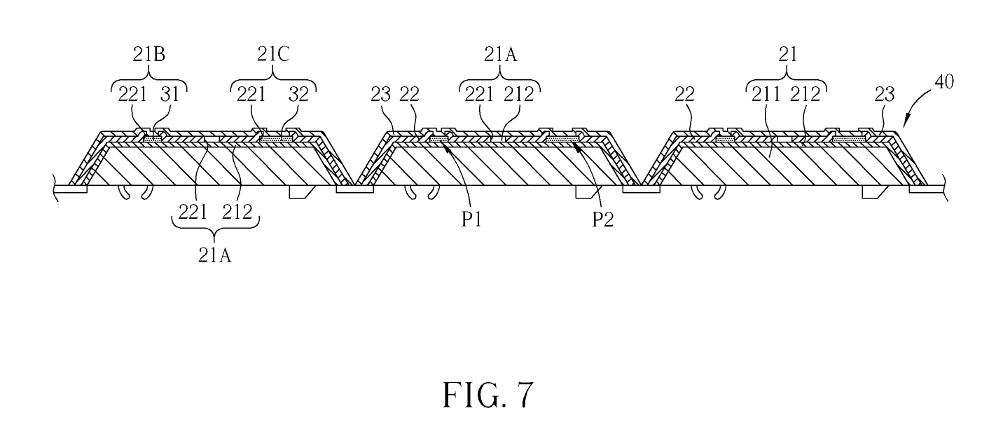

FIGS. 6 and 7 illustrate the third embodiment of the present invention, which is substantially the same as the second embodiment. The only difference is that, after Step 111 of transparent plastic body injection molding and Step 112 of primer paint spraying, Step 11 further includes:

Step 113 of first region printing: printing a first color body 31 on a first region P1 of the primer paint 212;

Step 114 of first baking: performing a first baking process on the transparent plastic body 211 to harden the first color body 31;

Step 115 of second region printing: printing a second color body 32 on a second region P2 of the primer paint 212; and

Step 116 of second baking: performing a second baking process on the transparent plastic body 211 to harden the second color body 32.

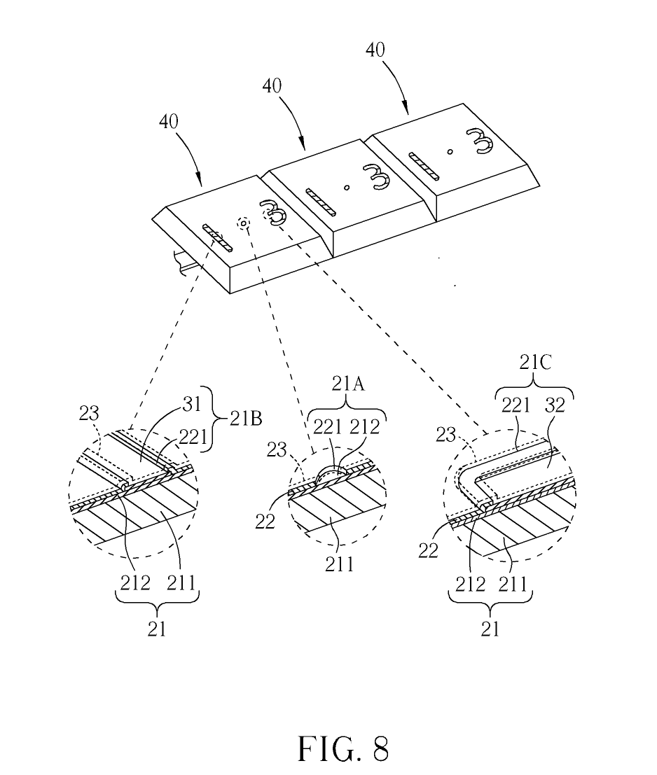

Thereby, referring to FIG. 8, at least a pattern portion 21A constituted by the hollowed portion 221 and the correspondingly exposed primer paint 212, at least a first auxiliary pattern portion 21B constituted by the hollowed portion 221 and the correspondingly exposed first color body 31, and at least a second auxiliary pattern portion 21C constituted by the hollowed portion 221 and the correspondingly exposed second color body 32 are formed on the transparent plastic body 211.

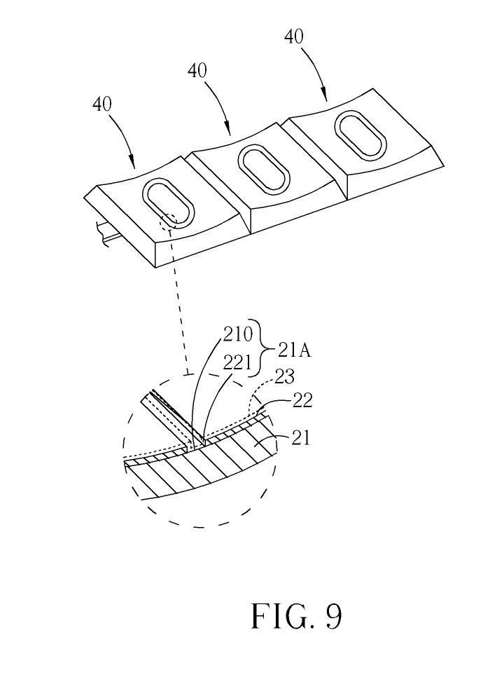

More specifically, the pattern (i.e. the pattern portion 21A, and the first and the second auxiliary pattern portion 21B and 21C) on the keycap structure 40 of the present invention is formed through spray-coating an entire to-be-processed surface 210, no matter how many to-be-processed surfaces 210 there are in a working piece, with a final coating 22 in a single step of large-area-spraying, fast and conveniently, and then engraving the final coating 22 with a laser beam 91 to form a hollowed portion 221, which is also a profile of the pattern. The pattern is presented by the color underlying the final coating 22 viewed from the hollowed portion 221. Accordingly, no matter in which embodiments mentioned above, the to-be-processed surface 210 may be planar (as shown in FIG. 3) or non-planar (such as being concave as shown in FIG. 9) and allowed to be spray-coated in a large area, and thereafter the final coating 22 is perpendicularly engraved with a laser beam 91 to form a hollowed portion 221. It is very convenient.

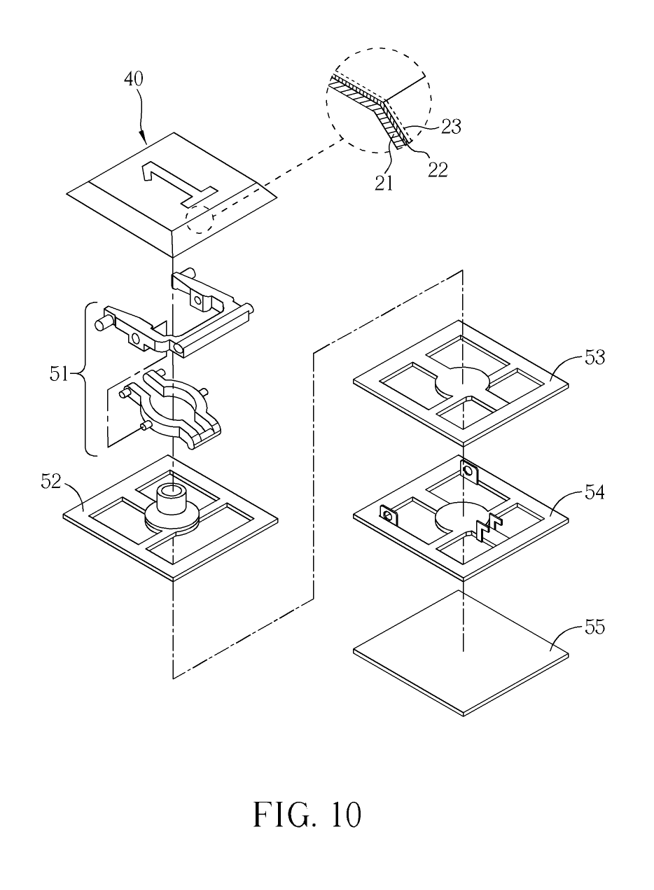

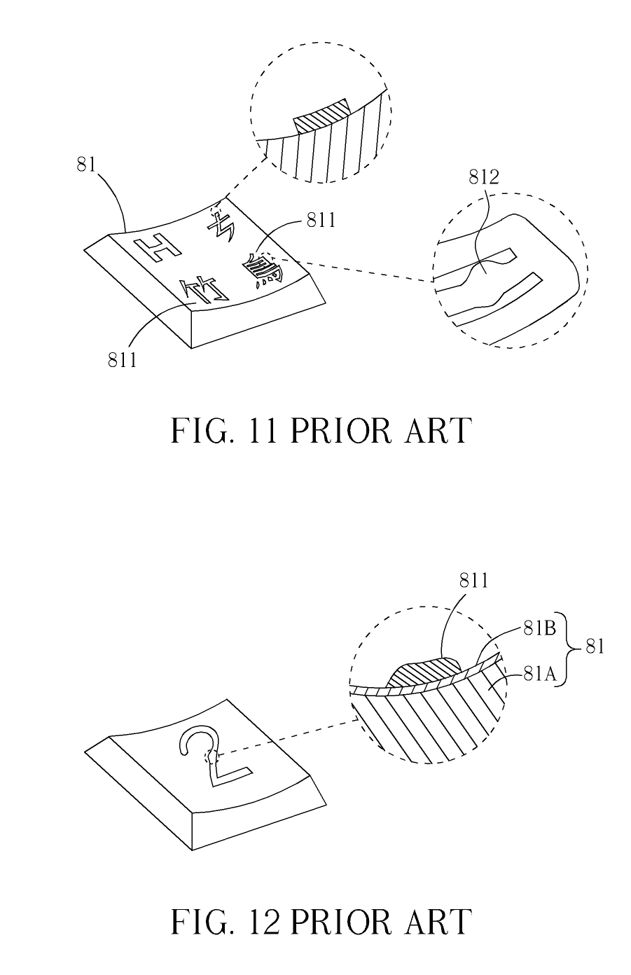

Moreover, the keycap structure 40 made from any of the aforesaid embodiments can be utilized in a computer keyboard. When it is utilized in the computer keyboard, referring to FIG. 10, a lift support device 51, a resilient member 52, a thin film circuit 53, a base 54, and a light guide plate 55 are further disposed within the colored plastic body 21 to form a keyboard module, to serve press and switch functions. These members can be disposed in well known manners and the detail is not described herein for concision.

The advantages and effects of the present invention include:

1. A complicated pattern can be formed. In the present invention, a colored plastic body is pre-formed and a to-be-processed surface (or an entire exterior) of the colored plastic body is spray-coated with a final coating. After the final coating is baked to harden on the to-be-processed surface, the final coating is laser-engraved to form a hollowed portion, which is also a profile of the pattern. The pattern is presented by the to-be-processed surface viewed through the hollowed portion. Because the laser beam can be adjusted to have a very tiny working diameter (currently, at least 40 micrometers can be obtained) and the final coating has hardened on the to-be-processed surface to become a hard material, very complicated but clear pattern including character, letter, number or decorative design can be depicted on the keycap.

2. A complicated pattern can be precisely formed even on a non-planar surface. The final coating in the present invention is sprayed on an entire to-be-processed surface of the colored plastic body, and accordingly no matter the surface is planar, concave, or irregular, it can be spray-coated uniformly and completely. Such spray-coating ought to be accomplished by for example a well known technique. Then, the laser tool can be moved so as to engrave perpendicularly the final coating on a non-planar surface to form the hollowed portion. Therefore, a complicated pattern can be still precisely formed on a non-planar surface.

Those skilled in the art will readily observe that numerous modifications and alterations of the device and method may be made while retaining the teachings of the invention.

What is claimed is:

1. A method of making a keycap structure, comprising steps of:
forming at least a colored plastic body having a to-be-processed surface;
coating the to-be-processed surface with a final coating;
baking the colored plastic body and the final coating to allow the final coating to harden on the to-be-processed surface;
performing a laser engraving process on the final coating to form at least a hollowed portion, wherein the hollowed portion and the correspondingly exposed to-be-processed surface together constitute at least a pattern portion;
covering the pattern portion and the final coating with a transparent layer for protection; and
performing a finishing process on the at least a colored plastic body to obtain a keycap structure.

2. The method of claim 1, wherein the at least a colored plastic body is formed through injection-molding a colored plastic material.

3. The method of claim 1, wherein the pattern portion comprises a character, letter, decorative design, figure, symbol, or number, for indication.

4. The method of claim 1, wherein a plurality of keycap structures are obtained in the finishing process.

5. The method of claim 1, wherein the step of forming the at least a colored plastic body comprises:
injection-molding a transparent plastic material to form a transparent plastic body; and
spray-coating the transparent plastic body with a primer paint, wherein a surface of the primer paint is the to-be-processed surface;
such that, the transparent plastic body and the primer paint constitute the colored plastic body, and the hollowed portion and the correspondingly exposed primer paint constitute the at least a pattern portion.

6. The method of claim 5, wherein the step of forming the at least a colored plastic body further comprises:
printing a first color body on a first region of the primer paint,
wherein the hollowed portion and the correspondingly exposed first color body constitute at least a first auxiliary pattern portion.

7. The method of claim 6, wherein the step of forming the at least a colored plastic body further comprises:
performing a first baking process on the transparent plastic body to harden the first color body.

8. The method of claim 5, wherein the step of forming the at least a colored plastic body further comprises:
printing a second color body on a second region of the primer paint,
wherein the hollowed portion and the correspondingly exposed second color body constitute at least a second auxiliary pattern portion.

9. The method of claim 8, wherein the step of forming the at least a colored plastic body further comprises:
performing a second baking process on the transparent plastic body to harden the second color body.
